(19) United States
(12) Patent Application Publication
(10) Pub. No.: US 2007/0141448 A1
(43) Pub. Date: Jun. 21, 2007

(54) Direct-type fuel cell and direct-type fuel cell system

(75) Inventors: Hideyuki Ueda, Osaka (JP); Shinsuke Fukuda, Osaka (JP); Takashi Akiyama, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/640,176

(22) Filed: Dec. 18, 2006

(30) Foreign Application Priority Data
Dec. 20, 2005 (JP) 2005-366063

(51) Int. Cl. H01M 4/94; H01M 8/02

(52) U.S. Cl. 429/44; 429/38; 429/42

(57) ABSTRACT

A direct-type fuel cell having excellent power generating characteristics even under operating conditions utilizing a high concentration fuel at low air flow rates. The anode includes an anode-side diffusion layer that faces the fuel flow channel and an anode-side catalyst layer in contact with the electrolyte membrane. The cathode includes a cathode-side diffusion layer that faces the air flow channel and a cathode-side catalyst layer in contact with the electrolyte membrane. A surface area of the anode-side diffusion layer facing the fuel flow channel or both a surface area of the anode-side diffusion layer facing the fuel flow channel and a surface area of the cathode-side diffusion layer facing the air flow channel have a critical surface tension of penetrating wettability of 22 to 40 mN/m.

### FIELD OF THE INVENTION

The present invention relates to a direct-type fuel cell that directly uses fuel without reforming it into hydrogen and to a system including the same.

### BACKGROUND OF THE INVENTION

Recently, portable small-sized electronic appliances, such as cellular phones, personal digital assistants (PDAs), notebook PCs, and video cameras, have been becoming more and more sophisticated, and the electric power consumed by these appliances and the continuous operating time thereof have been increasing commensurately. To cope with this, the power sources of these appliances are strongly required to have higher energy density. Currently, lithium secondary batteries are mainly used as the power source of these appliances, but it is predicted that the energy density of lithium secondary batteries will reach its limit at about 600 Wh/L around 2006. As an alternative power source to lithium secondary batteries, it is desired to bring fuel cells using a polymer electrolyte membrane into practical use as early as possible.

Among fuel cells, direct-type fuel cells (e.g., direct methanol fuel cells), are receiving attention since they have high theoretical energy density, utilize an organic fuel that is easy to store, and are capable of easy system simplification. Direct-type fuel cells generate electric power by directly supplying fuel to the anode without reforming it into hydrogen and oxidizing the fuel.

A direct-type fuel cell has a membrane electrode assembly (MEA), which is composed of a polymer electrolyte membrane sandwiched between an anode and a cathode. Each of the anode and the cathode comprises a catalyst layer and a diffusion layer. The MEA is sandwiched between separators. In the case of a direct methanol fuel cell, methanol or methanol aqueous solution is supplied as the fuel to the fuel flow channel of the anode-side separator, and air is supplied to the air flow channel of the cathode-side separator. The electrode reactions of a direct methanol fuel cell are as follows.
Anode: CH₃OH+H₂O→CO₂+6H⁺+6e⁻
Cathode: 3/2O₂+6H⁺+6e⁻→3H₂O

On the anode, methanol reacts with water to produce carbon dioxide, protons, and electrons. The protons produced on the anode migrate to the cathode through the electrolyte membrane. On the cathode, these protons and oxygen combine with electrons that have passed through an external circuit to produce water.

In order to bring direct methanol fuel cells into practical use, the following problems need to be considered.

A first problem is “methanol crossover”, which is a phenomenon in which methanol supplied to the fuel flow channel migrates to the cathode, without reacting, through the electrolyte membrane. An ion exchange membrane comprising perfluoroalkyl sulfonic acid is used as the electrolyte membrane of direct methanol fuel cells in view of its proton conductivity, heat resistance, and acid resistance. This type of electrolyte membrane is composed of a main chain of hydrophobic polytetrafluoroethylene (PTFE) and side chains of perfluoro groups having hydrophilic sulfonic acid groups at the terminals. Since methanol has both hydrophilic and hydrophobic moieties, it easily passes through the electrolyte membrane.

Methanol crossover lowers not only fuel utilization rate but also cathode potential. Thus, if the crossover increases, the power generating characteristics degrade significantly. The occurrence of methanol crossover tends to increase as the methanol concentration in the fuel becomes higher. Hence, the currently used methanol solution has a methanol concentration of approximately 2 to 4 mol/L. The use of such low concentration fuel is a large obstacle to the reduction of the size of fuel cell systems.

Therefore, to reduce methanol crossover, a large number of proposals have been made, such as development of new electrolyte membranes and improvements of anode-side catalyst layers and diffusion layers.

For example, Japanese Laid-Open Patent Publication No. 2002-110191 proposes evenly supplying fuel to the anode by suppressing methanol crossover upstream of the fuel flow channel and insufficient supply of methanol downstream of the fuel flow channel. To do this, the methanol permeation coefficient of the anode-side diffusion layer is made greater more downstream of the fuel flow channel. The anode-side diffusion layer comprises a substrate such as carbon paper and a mixed layer formed on the surface thereof, and the mixed layer comprises carbon black and polytetrafluoroethylene. This publication proposes such methods as reducing the thickness of the mixed layer, the amount of polytetrafluoroethylene, or the water-repellency of carbon black, or increasing the pores of the mixed layer, along the flow direction of fuel.

A second problem is clogging of the cathode with water (flooding) and dry-up of the MEA (dry-up). On the cathode side of direct methanol fuel cells, there is a large amount of water, which includes water produced by power generation, water produced by catalyst combustion reaction of crossover methanol, and crossover water. Such water clogs the air flow channel due to condensation inside the pores of the cathode. Thus, when a small amount of air is supplied to the cathode by using a small air pump, blower or the like, the supply of the air is impeded. As a result, the stability of power generation at high current densities is significantly impaired. Such clogging of the cathode with water can be suppressed, for example, by supplying a large amount of air. However, to supply a large amount of air, it is necessary to use a large-sized air pump or blower and increase the driving power thereof. Further, if an excessively large amount of air is supplied, the polymer electrolyte contained in the electrolyte membrane and the catalyst layer of the MEA becomes dry. As a result, the proton conductivity of the MEA degrades, which may cause a significant deterioration of power generating characteristics.

In order to continuously generate power at high current densities, Japanese Laid-Open Patent Publication No. 2004-247091 proposes making the anode diffusion layer hydrophilic and making the cathode diffusion layer hydrophobic. This publication further proposes forming an underlayer between the catalyst layer and the diffusion layer. The proposed underlayer has properties suitable for the anode or the cathode and comprises conductive carbon powder and a binder.

Also, Japanese Laid-Open Patent Publications No. 2002-289200 and No. 2002-289201 propose dispersing a moisture-retention component containing a metal oxide inside the pores of the catalyst layer or diffusion layer.

Fuel cells can be made more compact and more lightweight with longer operation time by utilizing a high concentration methanol solution and reducing the air flow rate. However, under such operating conditions, it is difficult for the above-mentioned conventional proposals to provide excellent power generating characteristics without lowering fuel utilization efficiency.

In Japanese Laid-Open Patent Publication No. 2002-110191, the mixed layer of carbon black and polytetrafluoroethylene is formed on the catalyst layer side of the anode-side diffusion layer. In Japanese Laid-Open Patent Publication No. 2004-247091, the anode-side diffusion layer itself is made hydrophilic. Thus, the face of the anode-side diffusion layer facing the fuel flow channel is believed to have a high penetrating wettability. For example, it is expected to have a critical surface tension of penetrating wettability of 50 mN/m or more. Therefore, if a high concentration methanol solution is supplied, the amount of fuel moving in the thickness direction of the diffusion layer is believed to significantly increase upstream of the fuel flow channel. Furthermore, if a small amount of a high concentration methanol solution which is very close to the amount consumed by power generation is supplied, the amount of fuel is believed to become insufficient downstream of the fuel flow channel, thereby resulting in a significant deterioration of power generating characteristics.

Also, in the fuel cells of Japanese Laid-Open Patent Publications No. 2002-110191 and No. 2004-247091, due to the presence of the mixed layer or the underlayer on the anode side, the dischargeability of carbon dioxide which is a reaction product degrades. Hence, the power generating characteristics at high current densities may deteriorate.

Further, Japanese Laid-Open Patent Publication No. 2004-247091 does not propose a specific means for solving the problem of the clogging of the cathode with water which occurs when the air flow rate is lowered.

Japanese Laid-Open Patent Publications No. 2002-289200 and No. 2002-289201 intend to solve the problems of the clogging of the cathode with water and the dry-up of the MEA in polymer electrolyte fuel cells (PEFCs) using hydrogen as fuel, by controlling the water retention of the catalyst layer and the diffusion layer. Hence, these publications are not directed to direct-type fuel cells where there is a large amount of water on the cathode side.

### BRIEF SUMMARY OF THE INVENTION

In view of the above, it is therefore an object of the present invention to ensure uniform supply of fuel to the whole area of the catalyst layer, reduce fuel crossover, and improve the dischargeability of carbon dioxide (reaction product) or suppress the clogging of the cathode with water. According to the present invention, even under operating conditions employing a high concentration fuel at a low air flow rate, degradation of fuel utilization efficiency is suppressed. Also, it is possible to provide a direct-type fuel cell with excellent power generating characteristics and a system including the same.

The present invention relates to a direct-type fuel cell including: a membrane electrode assembly including an anode, a cathode, and an electrolyte membrane interposed between the anode and the cathode; an anode-side separator with a groove that faces the anode, the groove serving as a fuel flow channel; and a cathode-side separator with a groove that faces the cathode, the groove serving as an air flow channel. The anode comprises an anode-side diffusion layer that faces the fuel flow channel and an anode-side catalyst layer in contact with the electrolyte membrane. The cathode comprises a cathode-side diffusion layer that faces the air flow channel and a cathode-side catalyst layer in contact with the electrolyte membrane. A surface area of the anode-side diffusion layer facing the fuel flow channel or both a surface area of the anode-side diffusion layer facing the fuel flow channel and a surface area of the cathode-side diffusion layer facing the air flow channel have a critical surface tension of penetrating wettability of 22 to 40 mN/m.

At least one of the surface area of the anode-side diffusion layer facing the fuel flow channel and the surface area of the cathode-side diffusion layer facing the air flow channel preferably has a gas permeability of 200 to 1000 cc/(cm²·min·kPa).

At least one of the surface area of the anode-side diffusion layer facing the fuel flow channel and the surface area of the cathode-side diffusion layer facing the air flow channel preferably has a porous surface layer (diffusion surface layer), and the diffusion surface layer comprises water-repellent resin fine particles and a water-repellent binder.

Preferably, the water-repellent resin fine particles are present in a larger amount on the surface side (separator side) of the diffusion surface layer than on the inner side thereof (for example, the substrate side of the diffusion layer). As used herein, the substrate of the diffusion layer refers to the portion of the diffusion-layer-forming structural component excluding the diffusion surface layer.

At least one of the surface of the groove of the anode-side separator and the surface of the groove of the cathode-side separator preferably has a contact angle of 120° or more with water.

At least one of the surface of the groove of the anode-side separator and the surface of the groove of the cathode-side separator preferably has a surface layer (groove surface layer), and the groove surface layer preferably comprises water-repellent resin fine particles and a water-repellent binder.

Preferably, the water-repellent resin fine particles are present in a larger amount on the surface side (diffusion layer side) of the groove surface layer than on the inner side thereof (for example, the substrate side of the separator). As used herein, the substrate of the separator refers to the portion of the separator-forming structural component excluding the groove surface layer.

The diffusion surface layer preferably has pores having irregular inner walls.

Also, the groove surface layer preferably has pores having irregular inner walls.

The present invention also pertains to a direct-type fuel cell system including: the above-described direct-type fuel cell; a fuel supply unit for supplying fuel to the direct-type fuel cell; and an air supply unit for supplying air to the direct-type fuel cell. The fuel supply unit is capable of setting the amount of fuel supplied to the direct-type fuel cell to 1.1 to 2.2 times the amount of fuel consumed by power generation.

The air supply unit is preferably capable of setting the amount of air supplied to the direct-type fuel cell to 3 to 20 times the amount of air consumed by power generation.

According to the present invention, it is possible to ensure even supply of fuel to the whole area of the catalyst layer, reduce fuel crossover, and improve dischargeability of carbon dioxide (reaction product) or suppress the clogging of the cathode with water. As a result, even under operating conditions employing a high concentration fuel at a low air flow rate, it is possible to suppress degradation of fuel utilization efficiency and provide a direct-type fuel cell with excellent power generating characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic cross-sectional view showing the structure of a direct-type fuel cell according to one embodiment of the present invention; and

FIG. 2 is a schematic view of a direct-type fuel cell system according to one embodiment of the present invention.

### DETAILED DESCRIPTION OF THE INVENTION

One of the characteristics of the direct-type fuel cell according to the present invention is that the surface area of the anode-side diffusion layer facing the fuel flow channel has a critical surface tension of penetrating wettability of 22 to 40 mN/m. Thus, the surface area of the anode-side diffusion layer facing the fuel flow channel has a porous surface with low surface energy, so that excessive fuel is unlikely to enter the pores of the diffusion layer. Therefore, even when a high concentration fuel is supplied to the fuel cell, the permeation speed of the fuel can be controlled such that it is uniform throughout the diffusion layer. As a result, it is possible to suppress the crossover upstream of the fuel flow channel due to the excessive supply of the fuel and the concentration polarization due to the insufficient supply of the fuel downstream thereof. That is, even when a higher concentration fuel than a conventional one is used in a fuel cell, it is possible to enhance fuel utilization efficiency (reduce fuel loss) and improve power generating characteristics.

If the critical surface tension of penetrating wettability of the surface area of the anode-side diffusion layer facing the fuel flow channel is more than 40 mN/m, the surface of the diffusion layer easily becomes wet with fuel, so that the permeation speed of the fuel in the diffusion layer significantly increases. Hence, particularly when a high concentration fuel is used, the crossover of the fuel increases, thereby resulting in a significant deterioration of power generating characteristics. On the other hand, if the critical surface tension of penetrating wettability is less than 22 mN/m, the supply of fuel to the catalyst layer becomes insufficient. Thus, the concentration polarization at the anode increases, thereby leading to deterioration of power generating characteristics. The critical surface tension of penetrating wettability is preferably 25 to 35 mN/m in terms of evenly supplying fuel to the catalyst layer.

It is adequate that the anode side diffusion layer has a critical surface tension of penetrating wettability of 22 to 40 mN/m at the surface area facing the fuel flow channel, but it may have a similar surface tension of penetrating wettability at the other area thereof.

Also, the surface area of the cathode-side diffusion layer facing the air flow channel preferably has a critical surface tension of penetrating wettability of 22 to 40 mN/m, and more preferably 25 to 35 mN/m. In this case, since the surface energy of the diffusion layer is optimized, the water in the cathode-side diffusion layer becomes droplets rather than taking the form of a film, and the droplets can easily move in the pores of the diffusion layer. Therefore, even under operating conditions of significantly low air flow rates, the clogging of the cathode with water can be suppressed. If the critical surface tension of penetrating wettability of the cathode-side diffusion layer exceeds 40 mN/m, the water in the cathode-side diffusion layer might be likely to take the form of a film. Thus, the supply of air is impeded, which may result in degradation of power generation stability at high current densities. On the other hand, if the critical surface tension of penetrating wettability of the cathode-side diffusion layer is less than 22 mN/m, the electric conductivity (current collecting property) of the diffusion layer may degrade.

It is adequate that the cathode-side diffusion layer preferably has a critical surface tension of penetrating wettability of 22 to 40 mN/m at the surface area facing the air flow channel, but it may have a similar critical surface tension of penetrating wettability at the other area thereof.

In the present invention, the critical surface tension of penetrating wettability of the diffusion layer means the limit value (lower limit value) of the surface tension of a liquid when the liquid dropped on the surface of the diffusion layer has a contact angle of 90° or more. That is, the greater the critical surface tension of penetrating wettability of the diffusion layer, the less the water repellency of the diffusion layer.

In the present invention, the critical surface tension of penetrating wettability can be determined, for example, as follows.

First, wetting index standard solutions with known surface tensions (wetting tension test mixtures available from Wako Pure Chemical Industries, Ltd.) are dropped on the surface of the diffusion layer and the contact angle is measured. When the contact angle between the surface of the diffusion layer and the droplet of a wetting index standard solution is 90°, the surface tension of this wetting index standard solution is defined as “the critical surface tension of penetrating wettability of the diffusion layer”. The contact angle between the surface of the diffusion layer and the droplet, as used herein, is a value obtained at 50 msec after dropping the wetting index standard solution. The contact angle can be measured by using, for example, an automatic contact angle meter (Kyowa Interface Science Co., Ltd.).

It should be noted that wetting tension test mixture No. 35 (surface tension 35 mN/m), for example, contains ethylene glycol monoethyl ether and formaldehyde.

The surface area of the anode-side diffusion layer facing the fuel flow channel preferably has a gas permeability of 200 to 1000 cc/(cm²·min·kPa), and more preferably 400 to 800 cc/(cm²·min·kPa). In this case, the dischargeability of carbon dioxide (reaction product) can be improved. If the gas permeability is less than 200 cc/(cm²·min·kPa), the dischargeability of carbon dioxide degrades, which may result in deterioration of power generating characteristics at high current densities. On the other hand, if the gas permeability exceeds 1000 cc/(cm²·min·kPa), the porosity of the diffusion layer becomes excessively high, which may result in degradation of electric conductivity (current collecting property) of the diffusion layer.

Also, the gas permeability of the surface area of the cathode-side diffusion layer facing the air flow channel is preferably 200 to 1000 cc/(cm²·min·kPa), and more preferably 400 to 800 cc/(cm²·min·kPa). In this case, the permeability of air into the diffusion layer can be heightened. If the gas permeability is less than 200 cc/(cm²·min·kPa), the power generating characteristics at high current densities may deteriorate. On the other hand, if the gas permeability exceeds 1000 cc/(cm²·min·kPa), the electrolyte membrane may become dry, so that its proton conductivity may lower or the electric conductivity of the diffusion layer may decrease.

The gas permeability can be determined by using, for example, a perm porometer (available from Porous Materials, Inc.).

While the differential pressure of air is increased, the penetration flux of air passing through the unit area of the diffusion layer per unit time is measured, and the rate of change of the penetration flux is obtained as the gas permeability.

The diffusion layer is preferably made of a material that is excellent in fuel diffusibility, dischargeability of carbon dioxide produced by power generation, and electronic conductivity. For example, a conductive porous material such as carbon paper or carbon cloth may be used as the diffusion layer or its substrate.

At least one of the surface area of the anode-side diffusion layer facing the fuel flow channel and the surface area of the cathode-side diffusion layer facing the air flow channel preferably has a porous surface layer (diffusion surface layer). The diffusion surface layer preferably contains water-repellent resin fine particles and a water-repellent binder.

When the diffusion layer has such a surface layer, its critical surface tension of penetrating wettability and gas permeability can be controlled easily. Due to the presence of the water-repellent resin fine particles on the surface of the anode-side or cathode-side diffusion layer, the surface area density (surface area per unit volume) of the diffusion layer increases. This means that the diffusion surface layer has a porous structure with very high water-repellency (with very low surface energy). In this case, the critical surface tension of penetrating wettability and gas permeability of the diffusion layer are greatly dependent on the surface properties, porous structure and thickness of the diffusion surface layer.

The fuel supplied to the fuel cell permeates through the whole area of the anode-side diffusion layer. When the anode-side diffusion layer has the above-described diffusion surface layer, excessive permeation of fuel upstream of the fuel flow channel is suppressed, so that the permeation speed of fuel in the anode-side diffusion layer can be easily controlled evenly. Also, the diffusion surface layer is unlikely to interfere with the discharge of carbon dioxide which is a reaction product on the anode side.

When the cathode-side diffusion layer has the diffusion surface layer, the water in the cathode-side diffusion layer is apt to become water droplets, so that the water can easily move in the pores of the diffusion layer. Hence, even under operating conditions of low air flow rates, the clogging of the cathode with water can be suppressed. Further, due to the porous structure and the effect of suppressing water clogging, the diffusion surface layer is unlikely to interfere with the permeation of air on the cathode side. Thus, it is possible to obtain a direct-type fuel cell with excellent power generating characteristics particularly at high current densities.

As described above, the preferable diffusion layer comprises a substrate and a diffusion surface layer formed thereon, and the diffusion surface layer comprises water-repellent resin fine particles and a water-repellent binder. In the diffusion surface layer, the weight ratio between the water-repellent resin fine particles and the water-repellent binder is preferably 95:5 to 60:40 such that micropores are ensured in the diffusion surface layer and falling off of the fine particles is prevented. When the diffusion surface layer is composed of fine particles, the pores of the diffusion surface layer are formed by inner walls with a large number of irregular asperities (fractals) derived from the particle shape. When the diffusion surface layer has pores formed by irregular inner walls, the water-repellency is further improved and super water-repellency is achieved.

The diffusion surface layer may be formed on one face or both faces of the diffusion layer. However, when it is formed on one face, the diffusion surface layer needs to be formed on the separator side of the diffusion layer.

The water-repellent resin fine particles contained in the diffusion surface layer preferably contain fluorocarbon resin with chemically stable carbon-fluorine (C—F) bonding. In this case, the diffusion surface layer becomes water-repellent. The fluorocarbon resin contained in the water-repellent resin fine particles is not particularly limited if it has the above-mentioned C—F bonding. Such examples include polytetrafluoroethylene resin (PTFE), tetrafluoroethylene-hexafluoropropylene copolymer (FEP), polyvinyl fluoride resin (PVF), polyvinylidene fluoride resin (PVDF), and tetrafluoroethylene-perfluoro (alkyl vinyl ether) copolymer (PFA). Among them, the use of PTFE or FEP is preferable in terms of maintaining water-repellency.

The mean particle size (volume basis median diameter) of the water-repellent resin fine particles is preferably 0.1 μm to 10 ρm in terms of improving water-repellency and preventing pore clogging. The mean particle size of the water-repellent resin fine particles can be measured, for example, by using a particle size distribution analyzer according to a laser diffraction scattering method, and there is no particular limitation with respect to the measurement method thereof.

The water-repellent binder contained in the diffusion surface layer preferably contains fluorocarbon resin or silicone resin. In this case, good adhesion of the diffusion surface layer to the substrate can be obtained without impairing the water-repellent effect of the diffusion surface layer. The fluorocarbon resin contained in the water-repellent binder is not particularly limited as long as it has C—F bonding. For example, polyvinyl fluoride resin (PVF) or polyvinylidene fluoride resin (PVDF) can be used.

Also, the silicone resin preferably has a molecular skeleton with siloxane bonding and side chains with methyl groups. For example, it may be pure silicone resin with methyl groups and phenyl groups or modified silicone resin. In the case of pure silicone resin with methyl groups and phenyl groups, if the number of methyl groups increases, the water-repellency increases. For example, silicone resin used in commercially available HIREC 1450 is preferable.

With respect to the method for forming the diffusion surface layer, there is no particular limitation. However, preferably, a water-repellent paste containing the above-mentioned water-repellent resin fine particles and water-repellent binder is spray coated, or applied according to a wet process by using a coater such as a doctor blade. The use of a method of repeating spray coating and air drying several times (multi-layer spray coating) is particularly preferable. In this case, the surface of the diffusion surface layer and the inner walls of the pores can be provided with a large number of irregular asperities (fractals) derived from the particle shape.

In the anode-side or cathode-side diffusion layer, the values of the critical surface tension of penetrating wettability and gas permeability are largely dependent on the surface properties, porous structure, and thickness of the diffusion surface layer. The surface properties and porous structure of the diffusion surface layer are dependent on the composition, solid content concentration, application method, drying temperature, and drying time of the water-repellent paste containing the water-repellent resin fine particles and the water-repellent binder. The thickness of the diffusion surface layer can be, for example, 5 to 100 μm. Preferably, it is 10 to 30 μm in terms of maintaining the low energy surface, improving the dischargeability of carbon dioxide and water, and ensuring the current collecting property.

The water-repellent resin fine particles are preferably present in a larger amount on the surface side of the diffusion surface layer than on the inner side thereof (the substrate side of the diffusion layer). The water-repellent resin fine particles can be provided in a larger amount on the surface side of the diffusion surface layer by controlling the drying temperature and drying time of the applied water-repellent paste. This is probably because the water-repellent resin fine particles in the applied water-repellent paste migrate to the surface side. For example, the surface-side half of the diffusion surface layer preferably contains not less than 60% of the total amount of the water-repellent resin fine particles contained in the diffusion surface layer, and contains more preferably 70 to 90%. In this case, it is possible to improve the water repellency of the surface side of the diffusion surface layer while ensuring good adhesion of the diffusion surface layer to the substrate.

The contact angle between the surface of the groove of the cathode-side separator and water is preferably 120° or more, and more preferably 130° or more. In this case, the water discharged from the cathode-side diffusion layer becomes water droplets and can easily move through the groove (air flow channel) of the separator. Thus, even under operating conditions of very low air flow rates, the clogging of the cathode with water can be suppressed.

When the critical surface tension of penetrating wettability of the cathode-side diffusion layer exceeds 40 mN/m, if the contact angle between the surface of the groove of the cathode-side separator and water is less than 120°, the water discharged from the diffusion layer might have the form of a film in the air flow channel. In this case, the air supply may be impeded, thereby resulting in a significant deterioration of power generation stability.

The contact angle between the surface of the groove of the anode-side separator and water is preferably 120° or more, and more preferably 130° or more. In this case, it is believed that fuel can easily move from the fuel flow channel to the anode-side diffusion layer.

To measure the contact angle between the surface of the groove of the separator and water, ion-exchange water (surface tension 72.8 mN/m) is used. The contact angle between the surface of the groove of the separator and ion-exchange water, as used herein, is a value obtained at 50 msec after dropping the ion-exchange water.

The separator may be any material if it is excellent in gas tightness, electronic conductivity, and electrochemical stability, and the material is not particularly limited. For example, the use of a carbon material (e.g., glassy carbon plate) as the substrate of the separator is preferable because of its electrochemical stability, lightness in weight and the like. Also, the shape of the fuel and air flow channels is not particularly limited either and may be, for example, serpentine.

At least one of the surface of the groove of the anode-side separator and the surface of the groove of the cathode-side separator preferably has a surface layer (groove surface layer) containing water-repellent resin fine particles and a water-repellent binder. In this case, the contact angle between the surface of the groove of the separator and water can be easily controlled.

When the groove of the cathode-side separator has a groove surface layer with very high water-repellency, the water discharged from the cathode-side diffusion layer becomes water droplets and can easily move through the groove of the separator. As a result, even under operating conditions of low air flow rates, the clogging of the cathode with water can be suppressed.

Also, when the groove of the anode-side separator has the groove surface layer, fuel can easily move from the fuel flow channel to the anode-side diffusion layer. Hence, surplus fuel is unlikely to be discharged from the fuel cell.

In the anode-side and cathode-side separators, the water-repellent resin fine particles are preferably present in a larger amount on the surface side of the groove surface layer than on the inner side thereof (the substrate side of the separator). The values of the contact angle between the surface of the groove of the separator and water are largely dependent on the surface properties of the groove surface layer. The surface properties of the groove surface layer are dependent on the composition, solid content concentration, application method, drying temperature, and drying time of the water-repellent paste containing the water-repellent resin fine particles and the water-repellent binder.

In the present invention, in order to reduce the contact resistance between the separator and the diffusion layer, it is preferable not to form the surface layer on the area of the anode-side separator in contact with the anode-side diffusion layer and the area of the cathode-side separator in contact with the cathode-side diffusion layer. That is, it is preferable not to form the surface layer on the ribs between the groove of the separator.

It is preferred that the groove surface layer also has pores that are formed by irregular inner walls. The groove surface layer preferably contains the same water-repellent resin fine particles and water-repellent binder as those of the diffusion surface layer. Also, the groove surface layer can be formed so as to have the same thickness and structure as those of the diffusion surface layer in the same manner as the diffusion surface layer. As the production method, the use of multi-layer spray coating is preferable as in the case of the diffusion surface layer.

The catalyst layer preferably contains catalyst-metal-carrying conductive carbon particles or catalyst metal fine particles and a polymer electrolyte. The catalyst metal of the anode-side catalyst layer is, for example, a platinum (Pt)-ruthenium (Ru) alloy in the form of fine particles. Also, the catalyst metal of the cathode-side catalyst layer is, for example, Pt in the form of fine particles. The polymer electrolyte is preferably made of the same material as that of the electrolyte membrane in order to ensure the interfacial adhesion of the catalyst layer to the electrolyte membrane.

The electrolyte membrane may be any material that is excellent in proton conductivity, heat resistance, and chemical stability, and the material is not particularly limited. For example, the use of a material with a sulfonic acid group, such as perfluoroalkyl sulfonic acid resin or sulfonated polyimide resin, is preferable.

Examples of fuel include methanol, methanol aqueous solution, dimethyl ether, dimethyl ether aqueous solution, ethanol, and ethanol aqueous solution. Among them, the use of methanol aqueous solution is preferable. The concentration of the methanol aqueous solution is preferably, for example, 4 to 10 mol/L.

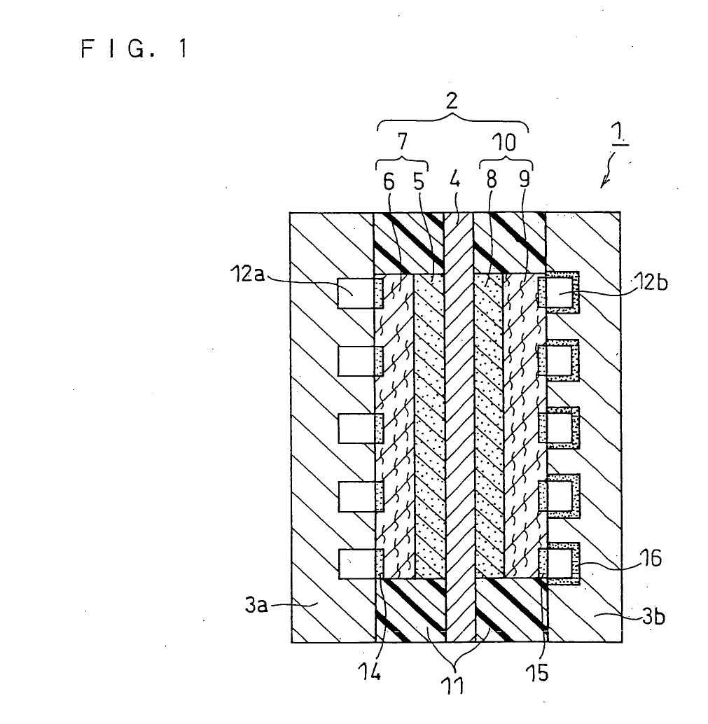

Referring now to FIG. 1, embodiments of the present invention are hereinafter described. FIG. 1 is an enlarged cross-sectional view of a direct-type fuel cell according to one embodiment of the present invention.

A fuel cell 1 includes an MEA (membrane electrode assembly) 2, which is sandwiched between an anode-side separator 3a and a cathode-side separator 3b. The MEA 2 includes: an anode 7 comprising an anode-side catalyst layer 5 and an anode-side diffusion layer 6; a cathode 10 comprising a cathode-side catalyst layer 8 and a cathode-side diffusion layer 9; and an electrolyte membrane 4 interposed between the anode 7 and the cathode 10. Gas sealing members 11 are fitted around the anode 7 and the cathode 10 so as to sandwich the electrolyte membrane 4, in order to prevent leakage of fuel and air. The anode-side separator 3a has a fuel flow channel 12a for supplying fuel to the anode and discharging reaction substances therefrom. The cathode-side separator 3b has an air flow channel 12b for supplying air to the cathode. Each of the fuel flow channel 12a and the air flow channel 12b is a groove of each of the anode-side separator 3a and the cathode-side separator 3b between the ribs thereof.

The anode side diffusion layer 6 and the cathode-side diffusion layer 9 have a diffusion surface layer 14 and a diffusion surface layer 15, respectively, at the surface areas facing the fuel flow channel 12a of the anode-side separator 3a and the air flow channel 12b of the cathode-side separator 3b. The groove of the cathode-side separator 3b, which constitutes the air flow channel 12b, also has a groove surface layer 16.

The gas sealing member 11 may be any known one with gas tightness. For example, a material with a three-layer structure of silicone rubber/polyetherimide(PEI)/silicone rubber can be used.

Next, a direct-type fuel cell system of the present invention is described. The system of the present invention includes the above-described fuel cell, a fuel supply unit for supplying fuel to the fuel cell, and an air supply unit for supplying air to the fuel cell. In this fuel cell system, the amount of fuel supplied to the fuel cell by the fuel supply unit can be set to 1.1 to 2.2 times the amount of fuel consumed by power generation. The fuel used is, for example, a methanol aqueous solution. The concentration of the methanol aqueous solution is preferably, for example, 4 to 10 mol/L. Even in the case of using such a high concentration methanol aqueous solution, the use of the fuel cell of the present invention enables a significant reduction in fuel crossover resulting from excessive supply of fuel. If the amount of fuel supply exceeds 2.2 times the amount of fuel consumed by power generation, fuel crossover may cause degradation of power generating characteristics. The amount of fuel consumed by power generation can be calculated according to Faraday's law. For example, when the electrode area (the area of the anode-side or cathode-side catalyst layer) is 36 cm² (6 cm×6 cm) and the current density is 150 mA/cm², the amount of fuel consumption is obtained by the equation: (150/1000)×(6×6)×60×(1/96485)×(1/6)=5.6×10⁻⁴ mol/min, provided that 1 F (faraday)=96485 C/mol and that the electrode reaction is a six-electron reaction.

When the fuel cell of the present invention is used, the amount of air supplied to the fuel cell by the air supply unit can be set to 2 to 30 times, or further 3 to 20 times the amount of air consumed by power generation. It is thus possible to avoid using a large air supply unit (e.g., an air pump or blower) and an increase in the driving electric power thereof. Also, since the dry-up of the polymer electrolyte in the polymer electrolyte membrane and the catalyst layer caused by increased air supply can be suppressed, degradation of the proton conductivity thereof can be suppressed. The amount of air consumed by power generation can be calculated according to Faraday's law in the same manner as the above. For example, when the electrode area (the area of the anode-side or cathode-side catalyst layer) is 36 cm² (6 cm×6 cm) and the current density is 150 mA/cm², the amount of air consumption is obtained by the equation: (150/1000)×(6×6)×60×(1/96485)×(3/2)×(1/6)×22.4×298/273×(1/0.21)=0.098 L/min.

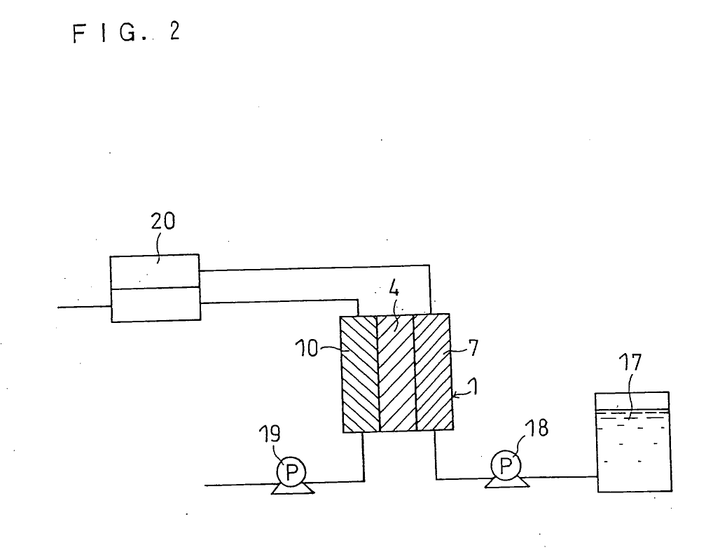

FIG. 2 is a schematic view showing one embodiment of a fuel cell system according to the present invention. This fuel cell system is a non-circulation type fuel cell system in which liquid and gas discharged from the fuel flow channel of the fuel cell are not recovered. That is, by making the amount of fuel supply approach the amount consumed by power generation as much as possible, the amount of fuel discharged from the fuel flow channel is minimized. Thus, such a non-circulation type fuel cell system does not need devices such as a cooler and a gas-liquid separator. The fuel cell 1 comprises a stack of one or more MEAs and separators. The MEA has the anode 7, the cathode 10, and the electrolyte membrane 4 interposed between the anode 7 and the cathode 10. The fuel cell 1 is equipped with a heater (not shown) for controlling the cell temperature. The fuel cell system of the present invention includes a fuel tank 17 and a fuel pump 18 that constitute the fuel supply unit, and an air pump 19 and a catalyst combustor 20 that constitute the air supply unit. The catalyst combustor 20 is composed of two combustion chambers divided by a porous sheet with a catalyst layer. One of the combustion chambers has only an inlet into which fuel discharged from the fuel cell 1 is introduced. Also, the other combustion chamber has an inlet into which air is introduced and an outlet from which air after catalyst combustion, containing water and carbon dioxide, is discharged.

First, an organic fuel in the fuel tank 17 is directly supplied to the anode 7 of the fuel cell 1 by the fuel pump 18. Next, air is supplied to the cathode 10 by the air pump 19. The fuel discharged from the anode 7 of the fuel cell 1 is oxidized in the catalyst combustor 20 by air discharged from the cathode 10, and is released into the atmosphere as air containing water and carbon dioxide. In this direct-type fuel cell system, fuel with a higher methanol concentration than usual can be supplied in an amount that is very close to the amount consumed by power generation, so that fuel utilization efficiency can be effectively improved.

The present invention is hereinafter described more specifically by ways of Examples. The following Examples, however, are not to be construed as limiting in any way the present invention.

### EXAMPLE 1

A fuel cell as illustrated in FIG. 1 was produced.

(i) Anode-Side Catalyst Layer

Anode-catalyst-carrying particles were prepared by placing 30% by weight of Pt fine particles and 30% by weight of Ru fine particles, both particles having a mean particle size of 3 nm, on carbon black particles with a mean primary particle size of 30 nm (ketjen black EC available from Mitsubishi Chemical Corporation), which are conductive carbon particles.

A dispersion of the anode-catalyst-carrying particles in an isopropanol aqueous solution was mixed with a dispersion of a polymer electrolyte in an ethanol aqueous solution. This liquid mixture was stirred in a bead mill, to prepare an anode catalyst paste. The weight ratio between the conductive carbon particles and the polymer electrolyte in the anode catalyst paste was 2:1. The polymer electrolyte used was a perfluorocarbon sulfonic acid ionomer (Flemion available from Asahi Glass Co., Ltd.).

The anode catalyst paste was applied onto a polytetrafluoroethylene (PTFE) sheet (Naflon available from NICHIAS Corporation) with a doctor blade and dried in the air at room temperature for 6 hours, to form the anode-side catalyst layer 5 in the form of a sheet. This PTFE sheet carrying the anode-side catalyst layer 5 was cut to a size of 6 cm×6 cm and laminated with the electrolyte membrane 4 such that the anode-side catalyst layer 5 was in contact with one face of the electrolyte membrane 4. The laminate was hot pressed at 130° C. at 8 MPa for 3 minutes, and the PTFE sheet was removed from the laminate. The amount of each of Pt and Ru contained in the anode-side catalyst layer 5 was 2.0 mg/cm². An ion exchange membrane of perfluoroalkyl sulfonic acid (Nafion 117 available from E.I. Du Pont de Nemours & Company) was used as the electrolyte membrane 4.

(ii) Cathode-Side Catalyst Layer

Cathode-catalyst-carrying particles were prepared by placing 50% by weight of Pt with a mean particle size of 3 nm on ketjen black EC. Using the particles, the cathode-side catalyst layer 8 was formed on the PTFE sheet in the same manner as the above. The cathode-side catalyst layer 8 was thermally bonded to the other face of the electrolyte membrane 4. The amount of Pt contained in the cathode-side catalyst layer 8 was also 2.0 mg/cm².

(iii) Anode-Side Diffusion Layer

A carbon paper with a thickness of 360 μm (TGP-H120 available from Toray Industries Inc.) was used as the substrate of the anode-side diffusion layer 6. The carbon paper was cut to a size of 6 cm×6 cm. Thereafter, the area of one face of the carbon paper which is to face the fuel flow channel 12a of the anode-side separator 3a was spray coated with a water-repellent paste A, followed by air drying for about 30 minutes. It should be noted that before the spray coating, the area of the carbon paper excluding the area which is to face the fuel flow channel 12a was masked. Further, after the spray coating and air drying were repeated several times, the carbon paper was dried at a high temperature of 70° C. for 30 minutes, so that the diffusion surface layer 14 with a thickness of approximately 20 μm was formed on the substrate. The water-repellent paste A used was HIREC 1450 available from NTT Advanced Technology Corporation, which contained PTFE resin fine particles (water-repellent resin fine particles) and silicone resin (water-repellent binder). The PTFE resin fine particles had a mean particle size of 1 μm.

(iv) Cathode-Side Diffusion Layer

The same substrate as that of the anode-side diffusion layer 6 was used for the cathode-side diffusion layer 9. The diffusion surface layer (PTFE/silicone layer) 15 with a thickness of approximately 20 μm was also formed on the cathode-side diffusion layer 9 in the same manner as in the above.

(v) Formation of MEA

The electrolyte membrane 4 with the catalyst layers 5 and 8 was sandwiched between the diffusion layers 6 and 9 such that the diffusion surface layers 14 and 15 were positioned outward. This was hot pressed at 130° C. at 4 MPa for 1 minute, so that the diffusion layers and the catalyst layers were bonded together.

The gas sealing members 11 were thermally bonded at 135° C. at 4 MPa to the electrolyte membrane 4 for 30 minutes, such that the gas sealing members 11 surrounded the anode 7 composed of the catalyst layer 5 and the diffusion layer 6, and the cathode 10 composed of the catalyst layer 8 and the diffusion layer 9, so as to sandwich the electrolyte membrane 4. This gave the MEA 2.

The MEA 2 was sandwiched between the anode-side separator 3a and the cathode-side separator 3b such that the fuel flow channel 12a faced the diffusion surface layer 14 and that the air flow channel 12b faced the diffusion surface layer 15. This was combined with current collector plates, heaters, insulator plates, and end plates (not shown), and this combination was secured with clamping rods to obtain a fuel cell (cell A). The clamping pressure was 20 kgf/cm² per unit area of the separator. The anode-side and cathode-side separators 3a and 3b used were 4-mm-thick carbon plates with outer dimensions of 10 cm×10 cm. The fuel flow channel 12a was of the serpentine type, with a width of 1.5 mm and a depth of 1 mm. The air flow channel 12b was also of the same serpentine type. The current collector plates and end plates used were gold-plated stainless steel plates.

### EXAMPLE 2

In forming the diffusion surface layer 14 (PTFE/silicone layer) on the substrate of the anode-side diffusion layer 6, the repeating number of spray coating and air drying was changed and the high temperature drying condition was changed to 80° C. for 60 minutes in order to make the thickness of the diffusion surface layer 14 to approximately 100 μm. A fuel cell (cell B) was produced in the same manner as in Example 1 except for these changes.

### EXAMPLE 3

A carbon paper with a thickness of 180 μm (TGP-060 available from Toray Industries Inc.) was used as the substrate of the anode-side diffusion layer 6 instead of TGP-H120. Also, in forming the diffusion surface layer 14 (PTFE/silicone layer) on the substrate of the anode side diffusion layer 6, the repeating number of spray coating and air drying was changed and the high temperature drying condition was changed to 70° C. for 20 minutes in order to make the thickness of the diffusion surface layer 14 to approximately 5 μm. A fuel cell (cell C) was produced in the same manner as in Example 1 except for these changes.

### EXAMPLE 4

In forming the diffusion surface layer 15 (PTFE/silicone layer) on the substrate of the cathode-side diffusion layer 9, the repeating number of spray coating and air drying was changed and the high temperature drying condition was changed to 80° C. for 60 minutes in order to make the thickness of the diffusion surface layer 15 to approximately 100 μm. A fuel cell (cell D) was produced in the same manner as in Example 1 except for these changes.

### EXAMPLE 5

The substrate of the cathode-side diffusion layer 9 was coated with a water-repellent paste B containing carbon black (CB) and PTFE resin fine particles instead of the water-repellent paste A. The water-repellent paste B was coated by a doctor blade process and dried at room temperature in the air for 8 hours. The dried paste was then baked at 360° C. in an inert gas (N₂) for 30 minutes to remove the surfactant. As a result, a CB/PTFE layer with a thickness of approximately 80 μm was formed. Further, a PTFE/silicone layer with a thickness of approximately 50 μm was formed on the CB/PTFE layer. The high temperature drying condition was set to 70° C. for 60 minutes. This gave the diffusion surface layer 14. A fuel cell (cell E) was produced in the same manner as in Example 1 except for these changes.

The water-repellent paste B was prepared as follows. First, carbon black (Vulcan XC-72R available from CABOT Corporation) was ultrasonically dispersed in an aqueous solution containing a surfactant (Triton X-100 available from Sigma-Aldrich Corporation) and then highly dispersed by using HIVIS MIX (available from PRIMIX Corporation). This dispersion was mixed with a dispersion of PTFE resin (mean particle size 0.2 μm) (D-1E available from Daikin Industries, Ltd.) and again highly dispersed to prepare the water-repellent paste B. In the water-repellent paste B, the weight ratio of carbon black (CB) to PTFE resin to surfactant was 6:3:1.

### EXAMPLE 6

A carbon paper with a thickness of 180 μm (TGP-060 available from Toray Industries Inc.) was used as the substrate of the cathode-side diffusion layer 9 instead of TGP-H120. Also, in forming the diffusion surface layer 15 (PTFE/silicone layer) on the substrate of the cathode-side diffusion layer 9, the repeating number of spray coating and air drying was changed and the high temperature drying condition was changed to 70° C. for 20 minutes in order to make the thickness of the diffusion surface layer 15 to approximately 5 μm. A fuel cell (cell F) was produced in the same manner as in Example 1 except for these changes.

### EXAMPLE 7

The substrate of the cathode-side diffusion layer 9 was coated with the water-repellent paste B instead of the water-repellent paste A, and a CB/PTFE layer with a thickness of approximately 70 μm was formed in the same manner as in Example 5 except that the gap of the doctor blade was changed. A fuel cell (cell G) was produced in the same manner as in Example 1 except for these changes.

### EXAMPLE 8

After the upper faces of the ribs between the groove of the cathode-side separator 3b were masked, the groove of the separator 3b was spray coated with the water-repellent paste A and air dried for about 30 minutes. The spray coating and air drying were repeated several times, and the paste was then dried at a high temperature of 7.0 for 30 minutes. As a result, the groove surface layer (PTFE/silicone layer) 16 with a thickness of approximately 10 μm was formed on the groove of the cathode-side separator 3b. A fuel cell (cell H) was produced in the same manner as in Example 1 except for these changes.

### EXAMPLE 9

After the upper faces of the ribs between the groove of the cathode-side separator 3b were masked, the groove of the separator 3b was spray coated with the water-repellent paste A and air dried for about 30 minutes. The spray coating and air drying were repeated a greater number of times than in Example 8, and the paste was then dried at a high temperature of 70° C. for 40 minutes. As a result, the groove surface layer (PTFE/silicone layer) 16 with a thickness of approximately 20 μm was formed on the groove of the cathode-side separator 3b. A fuel cell (cell I) was produced in the same manner as in Example 1 except for these changes.

### COMPARATIVE EXAMPLE 1

The diffusion surface layer 14 was not formed on the substrate of the anode-side diffusion layer 6. Further, the diffusion surface layer 15 was not formed on the substrate of the cathode-side diffusion layer 9. A fuel cell (cell 1) was produced in the same manner as in Example 1 except for these changes.

### COMPARATIVE EXAMPLE 2

The substrate of the anode-side diffusion layer 6 was coated with the water-repellent paste B instead of the water-repellent paste A, and a CB/PTFE layer with a thickness of approximately 70 μm was formed in the same manner as in Example 5 except that the gap of the doctor blade was changed. A fuel cell (cell 2) was produced in the same manner as in Example 1 except for these changes.

### COMPARATIVE EXAMPLE 3

A fuel cell (cell 3) was produced in the same manner as in Comparative Example 2 except for the use of the same cathode-side diffusion layer 9 as that of Example 7.

### COMPARATIVE EXAMPLE 4

First, a CB/PTFE layer with a thickness of approximately 80 μm was formed on substrate of the anode-side diffusion layer 6 in the same manner as in Example 5. Thereafter, a PTFE/silicone layer with a thickness of approximately 50 μm was formed on the CB/PTFE layer. A fuel cell (cell 4) was produced in the same manner as in Example 1 except for these changes.

### COMPARATIVE EXAMPLE 5

A fuel cell (cell 5) was produced in the same manner as in Comparative Example 4 except for the use of the same cathode-side diffusion layer as that of Example 5.

Table 1 summarizes the features of the surface layers of the respective cells thus produced.

TABLE 1

| | | | Groove |
|---|---|---|---|
| | Diffusion surface | Diffusion surface | surface layer of |
| | layer of anode-side | layer of cathode-side | cathode-side |
| Cell No. | diffusion layer | diffusion layer | separator |
| Cell A | PTFE/silicone layer | PTFE/silicone layer | None |
| | (20 μm) | (20 μm) | |
| Cell B | PTFE/silicone layer | PTFE/silicone layer | None |
| | (100 μm) | (20 μm) | |
| Cell C | PTFE/silicone layer | PTFE/silicone layer | None |
| | (5 μm) | (20 μm) | |
| Cell D | PTFE/silicone layer | PTFE/silicone layer | None |
| | (20 μm) | (100 μm) | |
| Cell E | PTFE/silicone layer | PTFE/silicone layer | None |
| | (20 μm) | (50 μm) | |
| | | CB/PTFE layer | |
| | | (80 μm) | |
| Cell F | PTFE/silicone layer | PTFE/silicone layer | None |
| | (20 μm) | (5 μm) | |
| Cell G | PTFE/silicone layer | CB/PTFE layer | None |
| | (20 μm) | (70 μm) | |
| Cell H | PTFE/silicone layer | PTFE/silicone layer | PTFE/ |
| | (20 μm) | (20 μm) | silicone layer |
| | | | (10 μm) |
| Cell I | PTFE/silicone layer | PTFE/silicone layer | PTFE/ |
| | (20 μm) | (20 μm) | silicone layer |
| | | | (20 μm) |
| Cell 1 | None | None | None |
| Cell 2 | CB/PTFE layer | PTFE/silicone layer | None |
| | (70 μm) | (20 μm) | |
| Cell 3 | CB/PTFE layer | CB/PTFE layer | None |
| | (70 μm) | (70 μm) | |
| Cell 4 | PTFE/silicone layer | PTFE/silicone layer | None |
| | (50 μm) | (20 μm) | |
| | CB/PTFE layer | | |
| | (80 μm) | | |
| Cell 5 | PTFE/silicone layer | PTFE/silicone layer | None |
| | (50 μm) | (50 μm) | |
| | CB/PTFE layer | CB/PTFE layer | |
| | (80 μm) | (80 μm) | |

The critical surface tension of penetrating wettability and gas permeability of the anode-side diffusion layers 6 and cathode-side diffusion layers 9 used in Examples 1 to 9 and Comparative Examples 1 to 5 were measured. Also, the contact angle between the surface of the groove of the cathode-side separator 3b and water was measured. Table 2 shows the results.

TABLE 2

| | Critical surface tension | | | | |
|---|---|---|---|---|---|
| | of penetrating | | Contact | Gas permeability | |
| | wettability [mN/m] | | angle | [cc/(cm² · min · kPa)] | |
| | | Cathode- | with water | Anode- | Cathode- |
| | Anode-side | side | [deg.] | side | side |
| Cell | diffusion | diffusion | Cathode-side | diffusion | diffusion |
| No. | layer | layer | separator | layer | layer |
| Cell A | 24 | 24 | 95 | 490 | 490 |
| Cell B | 22 | 24 | 95 | 200 | 490 |
| Cell C | 40 | 24 | 95 | 1000 | 490 |
| Cell D | 24 | 22 | 95 | 490 | 200 |
| Cell E | 24 | 20 | 95 | 490 | 110 |
| Cell F | 24 | 40 | 95 | 490 | 1000 |
| Cell G | 24 | 45 | 95 | 490 | 180 |
| Cell H | 24 | 24 | 135 | 490 | 490 |
| Cell I | 24 | 24 | 120 | 490 | 490 |
| Cell 1 | 53 | 53 | 95 | 510 | 510 |
| Cell 2 | 45 | 24 | 95 | 180 | 490 |
| Cell 3 | 45 | 45 | 95 | 180 | 180 |
| Cell 4 | 20 | 24 | 95 | 110 | 490 |
| Cell 5 | 20 | 20 | 95 | 110 | 110 |

The measurements were made as follows.

(1) Critical Surface Tension of Penetrating Wettability

Wetting index standard solutions with known surface tensions were dropped on the surface of each diffusion layer and the contact angle between the droplet and the diffusion layer was measured. When the contact angle between the droplet of a wetting index standard solution and a diffusion layer became 90°, the surface tension of the wetting index standard solution was defined as “the critical surface tension of penetrating wettability of the diffusion layer”. The contact angle as used herein was a value obtained 50 msec after the dropping of the wetting index standard solution. The contact angle was measured by using an automatic contact angle meter (Kyowa Interface Science Co., Ltd.).

(2) Gas Permeability

Using a perm porometer (available from Porous Materials, Inc.), the air penetration flux of a sample (diffusion layer 6, diffusion layer 9) was measured at 25° C. The sample size was made 7 cm². Also, with the pressure of the jig designed to catch the sample being at 20 kgf/cm², the differential pressure between the air supply side and the discharge side was changed up to 3 kPa at maximum. The rate of change of the air penetration flux relative to the air differential pressure was calculated. The value obtained in this manner was defined as gas permeability.

(3) Contact Angle With Water

Ion-exchange water (surface tension 72.8 mN/m) was dropped on the groove of each cathode-side separator, and the contact angle thereof was measured. The contact angle as used herein was a value obtained 50 msec after the dropping of the ion-exchange water. The contact angle was measured by using an automatic contact angle meter (Kyowa Interface Science Co., Ltd.).

Next, using the cells A to I of Examples and cells 1 to 5 of Comparative Examples, fuel cell systems as illustrated in FIG. 2 were fabricated, and their current-voltage characteristics and continuous power generating characteristics were evaluated in the following manner. Table 3 shows the results.

TABLE 3

| | 6M methanol (0.18 cc/min) | | | 6M methanol (0.18 cc/min) | | |
|---|---|---|---|---|---|---|
| | air (1.8 L/min) | | | air (0.3 L/min) | | |
| | | Continuous | | Current- | Continuous | |
| | Current- | power | Voltage | voltage | power | Voltage |
| | voltage | generating | retention | characteristics | generating | retention |
| Cell | characteristics | characteristics | rate | (V₀) | characteristics | rate |
| No. | (V₀)[V] | (V₂₄) [V] | [%] | [V] | (V₂₄)[V] | [%] |
| Cell A | 0.420 | 0.380 | 90 | 0.408 | 0.360 | 88 |
| Cell B | 0.394 | 0.335 | 85 | 0.378 | 0.322 | 85 |
| Cell C | 0.381 | 0.319 | 84 | 0.366 | 0.306 | 84 |
| Cell D | 0.392 | 0.323 | 82 | 0.377 | 0.301 | 80 |
| Cell E | 0.372 | 0.300 | 81 | 0.343 | 0.261 | 76 |
| Cell F | 0.398 | 0.343 | 86 | 0.387 | 0.315 | 81 |
| Cell G | 0.376 | 0.309 | 82 | 0.353 | 0.255 | 72 |
| Cell H | 0.425 | 0.413 | 97 | 0.420 | 0.395 | 94 |
| Cell I | 0.423 | 0.402 | 95 | 0.417 | 0.384 | 92 |
| Cell 1 | 0.203 | 0.096 | 47 | 0.107 | failed | — |
| Cell 2 | 0.244 | 0.173 | 71 | 0.216 | 0.138 | 64 |
| Cell 3 | 0.219 | 0.121 | 55 | 0.147 | failed | — |
| Cell 4 | 0.364 | 0.282 | 77 | 0.300 | 0.198 | 66 |
| Cell 5 | 0.355 | 0.222 | 63 | 0.276 | 0.115 | 42 |

(4) Current-Voltage Characteristics 1

A methanol aqueous solution of 6 mol/L (6M) was used as the fuel. The fuel was supplied to the fuel flow channel of the anode-side separator at a flow rate of 0.18 cc/min. Also, air was supplied to the air flow channel of the cathode-side separator at a flow rate 1.8 L/min. With the cell temperature kept at 60° C., power was generated at a current density of 150 mA/cm², and the effective voltage V₀ after the lapse of 15 minutes was measured. In this evaluation condition, the amount of fuel supply was set to 1.9 times the amount of fuel consumed by power generation, and the amount of air supply was set to 18.4 times the amount of air consumed by power generation.

(5) Continuous Power Generating Characteristics 1

After the measurement of the effective voltage V₀ (initial voltage), power was generated under the same condition as those for the current-voltage characteristics 1. After continuous power generation of 24 hours, the effective voltage V₂₄ was measured, and the ratio of the effective voltage V₂₄ to the initial voltage V₀ (voltage retention rate) was calculated.

(6) Current-Voltage Characteristics 2

The effective voltage V₀ was measured in the same manner as in the measurement of the current-voltage characteristics 1, except that the amount of air supply was set to 0.3 L/min (3.1 times the amount of air consumed by power generation).

(7) Continuous Power Generating Characteristics 2

After the measurement of the effective voltage V₀ (initial voltage), power was generated under the same condition as those for the current-voltage characteristics 2. After continuous power generation of 24 hours, the effective voltage V₂₄ was measured, and the ratio of the effective voltage V₂₄ to the initial voltage V₀ (voltage retention rate) was calculated.

In the case of the cells A to I, the surface area of the anode-side diffusion layer facing the fuel flow channel has a critical surface tension of penetrating wettability that is in the predetermined range. Thus, it is believed that the methanol was evenly supplied to the catalyst layer, and that due to the appropriate permeation speed of the fuel, the methanol crossover from the anode to the cathode was suppressed. The results indicate that a fuel cell with excellent power generating characteristics can be obtained even under operating conditions utilizing a high concentration methanol aqueous solution.

In the case of the cells A to D, F, H, and I, in addition to the above-mentioned feature, the surface area of the cathode-side diffusion layer facing the air flow channel has a critical surface tension of penetrating wettability that is in the preferable range and the cathode-side diffusion layer has a gas permeability that is also in the preferable range. Hence, it is thought that the dischargeability of carbon dioxide (reaction product) was improved, and that the clogging of the cathode with water was suppressed. The results show that a fuel cell with excellent power generating characteristics can be obtained even under operating conditions utilizing high-concentration methanol as the fuel at a low air flow rate.

With respect to the cells H and I, in particular, the contact angle between the surface of the groove of the cathode-side separator and water is optimized. For this reason, it is believed that the water discharged from the cathode-side diffusion layer became water droplets and could easily move through the groove of the separator. As a result, the clogging of the cathode with water was suppressed, and the continuous power generating characteristics were dramatically improved.

On the other hand, as for the cell 1, both the surface area of the anode-side diffusion layer facing the fuel flow channel and the surface area of the cathode-side diffusion layer facing the air flow channel have a critical surface tension of penetrating wettability that is above the upper limit value of the predetermined range. Hence, it is believed that the permeation speed of methanol in the anode-side diffusion layer was increased, thereby increasing the methanol crossover. It is also thought that the water in the cathode-side diffusion layer took the form of a film, thereby interfering with the air supply. As a result, the power generating characteristics significantly deteriorated.

In the case of the cells 2 and 3, the critical surface tension of penetrating wettability of the anode-side diffusion layer is beyond the upper limit value of the predetermined range. Thus, it is believed that the methanol crossover was increased. Also, the gas permeability of the anode-side diffusion layer is below the lower limit value of the preferable range. Hence, it is thought that degradation of the dischargeability of carbon dioxide (reaction product) resulted in significant degradation of the power generating characteristics. In the case of the cell 3, in particular, the critical surface tension of penetrating wettability of the cathode-side diffusion layer is also beyond the upper limit value of the preferable range. Hence, it is believed that the water in the cathode-side diffusion layer took the form of a film, thereby interfering with the air supply. Further, since the gas permeability of the cathode-side diffusion layer is also below the lower limit value of the preferable range, it is believed that the air supply was impeded. As a result, the power generating characteristics significantly deteriorated.

In the case of the cells 4 and 5, the critical surface tension of penetrating wettability of the anode-side diffusion layer is below the lower limit value of the predetermined range. Hence, it is believed that the supply of fuel to the catalyst layer was insufficient. Further, the gas permeability is also below the lower limit value of the preferable range. Hence, it is thought that the discharge of carbon dioxide (reaction product) became difficult, thereby increasing the concentration polarization and resulting in degradation of power generating characteristics. In the case of the cell 5, in particular, the critical surface tension of penetrating wettability of the cathode-side diffusion layer is below the lower limit value of the preferable range and, in addition, the gas permeability is also below the lower limit value of the preferable range. Thus, it is believed that the pores of the substrate of the diffusion layer were partially clogged with the carbon black and the PTFE resin fine particles, thereby resulting in degradation of air permeation and therefore continuous power generating characteristics.

The direct-type fuel cell of the present invention can directly utilize methanol, dimethyl ether, etc. as fuel without reforming it into hydrogen. Therefore, it is useful as the power source for portable small-sized electronic devices, such as cellular phones, personal digital assistants (PDA), notebook PCs, and video cameras. It is also applicable to the power source for electric scooters, etc.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A direct-type fuel cell comprising:
a membrane electrode assembly comprising an anode, a cathode, and an electrolyte membrane interposed between said anode and said cathode;
an anode-side separator with a groove that faces said anode, said groove serving as a fuel flow channel; and
a cathode-side separator with a groove that faces said cathode, said groove serving as an air flow channel,
wherein said anode comprises an anode-side diffusion layer that faces said fuel flow channel and an anode-side catalyst layer in contact with said electrolyte membrane,
said cathode comprises a cathode-side diffusion layer that faces said air flow channel and a cathode-side catalyst layer in contact with said electrolyte membrane,
a surface area of said anode-side diffusion layer facing said fuel flow channel or both a surface area of said anode-side diffusion layer facing said fuel flow channel and a surface area of said cathode-side diffusion layer facing said air flow channel have a critical surface tension of penetrating wettability of 22 to 40 mN/m.

2. The direct-type fuel cell in accordance with claim 1, wherein at least one of the surface area of said anode-side diffusion layer facing said fuel flow channel and the surface area of said cathode-side diffusion layer facing said air flow channel has a gas permeability of 200 to 1000 cc/(cm²·min·kPa).

3. The direct-type fuel cell in accordance with claim 1, wherein at least one of the surface area of said anode-side diffusion layer facing said fuel flow channel and the surface area of said cathode-side diffusion layer facing said air flow channel has a porous surface layer, and said surface layer comprises water-repellent resin fine particles and a water-repellent binder.

4. The direct-type fuel cell in accordance with claim 1, wherein at least one of a surface of said groove of said anode-side separator and a surface of said groove of said cathode-side separator has a contact angle of 120° or more with water.

5. The direct-type fuel cell in accordance with claim 4, wherein at least one of the surface of said groove of said anode-side separator and the surface of said groove of said cathode-side separator has a surface layer, and said surface layer comprises water-repellent resin fine particles and a water-repellent binder.

6. The direct-type fuel cell in accordance with claim 3, wherein said water-repellent resin fine particles are present in a larger amount on a surface side of said surface layer than on an inner side thereof.

7. The direct-type fuel cell in accordance with claim 5, wherein said water-repellent resin fine particles are present in a larger amount on a surface side of said surface layer than on an inner side thereof.

8. The direct-type fuel cell in accordance with claim 3, wherein said surface layer has pores having irregular inner walls.

9. The direct-type fuel cell in accordance with claim 5, wherein said surface layer has pores having irregular inner walls.

10. A direct-type fuel cell system comprising:
the direct-type fuel cell in accordance with claim 1;
a fuel supply unit for supplying fuel to said direct-type fuel cell; and
an air supply unit for supplying air to said direct-type fuel cell,
wherein said fuel supply unit is capable of setting the amount of fuel supplied to said direct-type fuel cell to 1.1 to 2.2 times the amount of fuel consumed by power generation.

11. The direct-type fuel cell system in accordance with claim 10, wherein said air supply unit is capable of setting the amount of air supplied to said direct-type fuel cell to 3 to 20 times the amount of air consumed by power generation.
